(19) United States
(12) Patent Application Publication
(10) Pub. No.: US 2026/0250887 A1
(43) Pub. Date: Aug. 27, 2026

(54) NYLON 66 FIBERS AND WOVEN/KNIT ARTICLE

(71) Applicant: Toray Industries, Inc., Chuo-ku, Tokyo (JP)

(72) Inventors: Mizuki OSAKI, Shizuoka (JP); Daiki KURACHI, Nagoya-shi, Aichi (JP); Masayuki IIZUKA, Nagoya-shi, Aichi (JP)

(73) Assignee: Toray Industries, Inc., Chuo-ku, Tokyo (JP)

(21) Appl. No.: 18/874,657

(22) PCT Filed: Jun. 16, 2023
(86) PCT No.: PCT/JP2023/022434

§ 371 Date: Dec. 13, 2024

(30) Foreign Application Priority Data
Jun. 16, 2022 (JP) 2022-096983

(51) Int. Cl. D01F 6/60; C08L 77/06; D03D 15/283

(52) U.S. Cl. CPC D01F 6/60; C08L 77/06; D03D 15/283; C08L 2203/12; C08L 2205/02; C08L 2207/20; D10B 2331/02; D10B 2401/063; D10B 2401/20

(57) ABSTRACT

The present invention relates to a nylon-66 fiber having a color tone YI value of 30 or less, a weight average molecular weight Mw/number average molecular weight Mn of 4.5 or less, and a z-average molecular weight Mz/weight average molecular weight Mw of 2.5 or less, as determined by a molecular weight distribution obtained by GPC measurement.

### CROSS REFERENCE TO RELATED APPLICATIONS

This application is the U.S. National Phase of PCT/JP2023/022434, filed Jun. 16, 2023, which claims priority to Japanese Patent Application No. 2022-096983, filed Jun. 16, 2022, the disclosures of these applications being incorporated herein by reference in their entireties for all purposes.

### FIELD OF THE INVENTION

The present invention relates to a nylon-66 fiber using a material-recycled polyhexamethylene adipamide resin and a woven and knitted fabric.

### BACKGROUND OF THE INVENTION

Due to improvement in environmental consciousness in recent years, values of environment-friendly materials, for example, products made from recycled materials, are increasing, and there is a demand for development of fibers made from recycled materials. As a similar approach, for example, nylon-6 is known as polyamide that can be chemically recycled by depolymerizing product scraps or polyamide scraps into caprolactam as a raw material, and then repolymerizing the caprolactam obtained by depolymerization to produce chips. However, for nylon-6, the depolymerization process and the repolymerization process are complicated and are difficult to control quality, and it is less cost-effective than so-called virgin polymers, which are polymers obtained by polymerizing fresh monomers, and therefore chemically recycled nylon-6 has not yet come into widespread use. Since a monomer component of nylon-66 is separated into two components, depolymerization is very difficult, and therefore chemically recycled nylon-66 has not yet been widely used.

On the other hand, a material recycling method is also known in which polyamide scraps are melted to produce chips without depolymerization. For example, Patent Literature 1 discloses a method for producing a recycled polyamide fiber by producing material-recycled polyamide resin chips through crushing and washing polyamide waste materials including nylon-66 all-gloss yarn, nylon-66 semi-gloss yarn, nylon-66 mat yarn, nylon-66 ultra-high strength yarn, nylon-66 high strength yarn, nylon-66 Fine Denier high strength yarn, nylon-66 waste fishing net wire, and nylon-66 waste cloth to reduce an oil component to 0.22 wt % and carrying out a dehydration step and a melt granulation step, and then by melt spinning the material-recycled polyamide chips.

Patent Literature 2 discloses a recycled polyamide crimped yarn for mainly industrial use, which has a modified or hollow cross section, a total fineness of 500 dtex to 3000 dtex, and a single yarn fineness of 5 dtex to 50 dtex, and which contains 5 mass % to 80 mass % of material-recycled polyamide resin chips obtained by melting and filtering molded product scraps such as polyamide fiber scraps or polymer scraps generated during yarn production steps, and method for producing the same.

### PATENT LITERATURE

Patent Literature 1: JP2020-2336A
Patent Literature 2: JP2013-155454A

### SUMMARY OF THE INVENTION

However, for the material-recycled polyamide polymer described in Patent Literature 1, although there are washing and drying steps aimed at reducing a content of an oil component as an impurity contained in the polyamide waste materials, which are somewhat effective in removing impurities, mainly oil components, adhering to a surface of the waste materials, it is not suitable for removing low molecular weight impurities contained inside the waste materials, and the remaining low molecular weight impurities cause a decrease in strength and elongation, which leads to yarn breakage in textile processing and poor passing performance in textile processing.

Polyamide polymers mainly suitable for industrial use, such as the one described in Patent Document 2, often use high viscosity (high molecular weight) polymers since they are required to ensure a degree of irregularity and have high strength. The waste materials used in material recycling also contain polymer scraps, but it is difficult to remove low molecular weight impurities from the polymer scraps, and the resulting material-recycled polyamide polymer contains a large amount of low molecular weight impurities. Especially, in a case of clothing use, a fiber surface area is increased as compared with the fineness range for industrial use, so there is a large amount of remaining low molecular weight impurities, which has a significant impact on raw yarn properties such as a decrease in strength and elongation. From the viewpoint of spinning performance, in addition to the remaining low molecular weight impurities, the material-recycled polyamide polymer also contains a large amount of high molecular weight impurities that are likely to cause thickening and heat deterioration due to influence of heat history. As a result, there are problems that the strength and elongation are easily reduced, and an amino terminal group content is easily varied, and yarn breakage occurs during textile processing, which leads to poor passing performance in textile processing, and dyeing differences occur in dyeing, which makes it difficult to satisfy strict fabric appearance inspection standards required for clothing use.

Polyamide is a polymer that is easily oxidized, and is easily oxidized and yellowed under an oxygen atmosphere or when exposed to oxygen in the air when it is hot. Therefore, the polyamide scraps described in Patent Literatures 1 and 2 are in a state of progressive yellowing due to heat history received during a fiber manufacturing step, heat history received during a fiber-to-product manufacturing step, moisture absorption during product use, oxidation by ultraviolet rays, and the like. Furthermore, when these materials are recycled, they are remelted and turned into fibers, which causes further yellowing and makes it difficult to satisfy strict color tone (whiteness) requirements for clothing use, which significantly limits the use thereof. The present invention is devised to solve the above-mentioned problems, and an object of the present invention is to provide a recycled nylon-66 fiber which has the same raw yarn properties and passing performance in textile processing as a virgin nylon-66 fiber and can produce high-quality woven and knitted fabrics with an excellent color tone.

In order to achieve the above object, the present invention adopts the following configurations.
(1) A nylon-66 fiber having a color tone YI value of 30 or less, a weight average molecular weight (Mw)/number average molecular weight (Mn) of 4.5 or less, and a z-average molecular weight (Mz)/weight average molecular weight (Mw) of 2.5 or less, as determined by a molecular weight distribution obtained by GPC measurement.
(2) The nylon-66 fiber according to (1), having a total fineness of 3 dtex to 200 dtex, a single yarn fineness of 0.2 dtex to 10 dtex, and a CV % of a continuous strength and elongation product of 10% or less.
(3) The nylon-66 fiber according to (1) or (2), containing 20 wt % or more of a material-recycled polyhexamethylene adipamide resin.
(4) A method for producing the nylon-66 fiber according to (3), including: a step of producing the polyhexamethylene adipamide resin, in which the step includes a step of cutting fiber scraps, a step of immersing the fiber scraps in hot water, a step of melting, filtering and discharging the fiber scraps, a step of water-cooling and cutting the discharged resin, and a step of immersing chips in hot water.
(5) A woven and knitted fabric containing the nylon-66 fiber according to (1) or (2).

The present invention can provide a recycled nylon-66 fiber which has the same raw yarn properties and passing performance in textile processing as a virgin nylon-66 fiber and can produce high-quality woven and knitted fabrics with an excellent color tone.

### DETAILED DESCRIPTION OF EMBODIMENTS OF THE INVENTION

A nylon-66 fiber according to an embodiment of the present invention has a color tone YI value of 30 or less, a weight average molecular weight Mw/number average molecular weight Mn of 4.5 or less, and a z-average molecular weight Mz/weight average molecular weight Mw of 2.5 or less, as determined by a molecular weight distribution obtained by GPC measurement.

A method for producing the nylon-66 fiber according to the embodiment of the present invention is a method for producing a nylon-66 fiber containing 20 wt % or more of a material-recycled polyhexamethylene adipamide resin, the method including a step of producing the polyhexamethylene adipamide resin, in which the step includes a step of cutting fiber scraps, a step of immersing the fiber scraps in hot water, a step of melting, filtering and discharging the fiber scraps, a step of water-cooling and cutting the discharged resin, and a step of immersing chips in hot water.

The present invention will be described in detail below.

The nylon-66 fiber according to the embodiment of the present invention is preferably a nylon-66 fiber blended with a material-recycled polyhexamethylene adipamide resin in an amount of 20 wt % or more of the fiber. That is, the nylon-66 fiber according to the embodiment of the present invention preferably contains 20 wt % or more of the material-recycled polyhexamethylene adipamide resin. In view of the recent growing awareness of global environmental conservation, the greater the blending amount, the more preferable, and a nylon-66 fiber containing 50 wt % to 100 wt % of the material-recycled polyhexamethylene adipamide resin with respect to fiber is still more preferable.

Note that the material-recycled polyhexamethylene adipamide resin is preferably obtained by a production method including a step of cutting fiber scraps, a step of immersing the fiber scraps in hot water, a step of melting, filtering and discharging the fiber scraps, a step of water-cooling and cutting the discharged resin, and a step of immersing chips in hot water. The production method will be described in detail later.

The nylon-66 fiber according to the embodiment of the present invention has a YI value of 30 or less. When a polyamide fiber (particularly a nylon-66, which is susceptible to heat deterioration) is produced using the material-recycled polyamide resin, a color tone of the fiber turns yellow due to heat history received in a melting filtration step and a hot water extraction step, resulting in a YI value of 5 or more. If the YI value exceeds 30, a desired color tone cannot be developed, and uses may be limited. By controlling the YI value to 30 or less, the fiber can be used for a woven and knitted fabric without any restrictions on uses. The YI value is preferably 25 or less, and more preferably 20 or less. The YI value can be measured using a multi-illuminant spectroscopy colorimeter (manufactured by Suga Test Instruments Co., Ltd.).

A molecular weight distribution of the nylon-66 fiber according to the embodiment of the present invention has a distribution ratio of weight average molecular weight (Mw)/number average molecular weight (Mn) of 4.5 or less, and a distribution ratio of z-average molecular weight (Mz)/weight average molecular weight (Mw) of 2.5 or less. By setting the distribution ratios within these ranges, it is possible to obtain a high-quality woven and knitted fabric having the same raw yarn properties as a virgin nylon-66 fiber and excellent in passing performance in textile processing.

The number average molecular weight (Mn), weight average molecular weight (Mw) and z-average molecular weight (Mz) referred to in the present invention can be determined from the molecular weight distribution obtained by gel permeation chromatography (GPC). Specifically, the molecular weight distribution is measured using a gel permeation chromatograph (GPC) as an apparatus and one “Shodex HEIP-G” column manufactured by Showa Denko K.K. and two “Shodex HEIP-606M” columns manufactured by Showa Denko K.K. As a measurement solvent, 5 mM of hexafluoroisopropanol containing sodium trifluoroacetate was used, and 3 mg of polymethyl methacrylate (PMMA) manufactured by Showa Denko K.K. as standard sample and 3 mg of the nylon-66 fiber were used, which were gently stirred at room temperature and then filtered using a 0.45 μm filter to prepare a solution. The molecular weight distribution of the prepared sample solution is measured using a “RI-104” refractive index detector manufactured by Showa Denko K.K. under conditions of a column temperature of 40° C. and a flow rate of 0.2 ml/min.

The nylon-66 fiber according to the embodiment of the present invention has a weight average molecular weight (Mw)/number average molecular weight (Mn) of 4.5 or less. The weight average molecular weight (Mw)/number average molecular weight (Mn) is an index of an extent of low molecular weight components, and the smaller this value is, the less low molecular weight impurities derived from monomers and oligomers are present. Within this range, it is possible to obtain a nylon-66 fiber having the same raw yarns properties as a virgin nylon-66 fiber and a good continuous strength and elongation product CV %, and excellent in the passing performance in textile processing. In the case where Mw/Mn exceeds 4.5, the continuous strength and elongation product CV % increases, and when subjected to textile processing, yarn breakage or the like occurs starting from points having locally low strength and elongation products, resulting in poor passing performance in textile processing. Preferably, Mw/Mn is 2.9 to 4.5, and more preferably, Mw/Mn is 2.9 to 4.0.

The nylon-66 fiber according to the embodiment of the present invention has a z-average molecular weight (Mz)/weight average molecular weight (Mw) of 2.5 or less. The z-average molecular weight (Mz)/weight average molecular weight (Mw) is an index of an extent of high molecular weight components, and the smaller this value, the smaller the amount of high molecular weight components. Within this range, it is possible to obtain a high-quality woven and knitted fabric with the same raw yarns properties as a virgin nylon-66 fiber, with suppressing generation of heat deterioration products, with a good amino terminal group content CV %, and without dyeing differences when dyed. In the case where Mz/Mw exceeds 2.5, a large amount of heat deterioration products are produced, the amino terminal group content CV % increases, and dyeing differences occur when dyed, resulting in a woven and knitted fabric with poor appearance. A continuous strength and elongation product tends to decrease and the continuous strength and elongation product CV % tends to increase, and yarn breakage is likely to occur in textile processing, and the passing performance in textile processing tends to deteriorate. Preferably, Mz/Mw is 1.0 to 2.5, and more preferably, Mz/Mw is 1.5 to 2.0.

The nylon-66 fiber of the present invention has an amino terminal group content of 3.5× 10-5 mol/g or more. More preferably, the amino terminal group content is 4.0×10⁻⁵ mol/g to 5.8×10⁻⁵ mol/g. Within this range, excellent color development can be obtained using typical dyes (acid dyes) and methods (normal pressure dyeing) used in dyeing. The amino terminal group content CV %, which indicates a variation in the amino terminal group content in a longitudinal direction of the fiber, is preferably 8% or less. Within this range, when dyed, a high-quality woven and knitted fabric without any dyeing difference can be obtained regardless of color tone.

The nylon-66 fiber according to the embodiment of the present invention preferably has a total fineness of 3 dtex to 200 dtex, a single yarn fineness of 0.2 dtex to 10 dtex, and a continuous strength and elongation product CV % of 10% or less.

The nylon-66 fiber according to the embodiment of the present invention preferably has a total fineness of 3 dtex to 200 dtex, and more preferably 10 dtex to 150 dtex. Within this range, even when material-recycled nylon-66 chips are used, it is possible to obtain raw yarn properties and quality equivalent to those of a virgin nylon-66 fiber, and it is possible to obtain a woven and knitted fabric with a texture particularly suitable for a clothing use.

The nylon-66 fiber according to the embodiment of the present invention preferably has a single yarn fineness of 0.2 dtex to 10 dtex, and more preferably 0.4 dtex to 5 dtex. Within this range, even when material-recycled nylon chips are used, it is possible to obtain raw yarn properties and quality equivalent to those of a virgin nylon-66 fiber, and it is possible to obtain a woven and knitted fabric with a texture particularly suitable for a clothing use.

The nylon-66 fiber according to the embodiment of the present invention preferably has a continuous strength and elongation product CV % of 10% or less. The lower the CV %, the smaller a variation in a tensile strength-elongation curve in the longitudinal direction of the fiber, and within this range, there will be no weak yarns having locally low strength and elongation products, and in textile processing, stable passing performance in textile processing will be obtained without yarn breakage. Since a fiber structure is also stable, a high-quality woven and knitted fabric can be obtained without dyeing differences regardless of color tone.

An average value of the continuous strength and elongation product is preferably 6.0 or more. Within this range, in textile processing, stable passing performance in textile processing can be obtained without yarn breakage. Furthermore, a minimum value of the continuous strength and elongation product is preferably 4.0 or more. The lower the minimum value, the more likely it is that points having locally low strength and elongation products will become weak yarn parts, and yarn breakage or the like will occur starting from those points. However, within this range, in textile processing, stable textile processability can be obtained without yarn breakage.

The continuous strength and elongation product in the present invention can be calculated as follows. First, a fiber sample is measured using “Tensilon®” manufactured by ORIENTEC CO., LTD. in accordance with JIS L1013 (2010), with constant-speed extension conditions of a grip interval of 50 cm and a tension rate of 50 cm/min, to draw a tensile strength-elongation curve 50 times (total length 25 m). An intensity is determined from a point showing a maximum intensity on the tensile strength-elongation curve, and the elongation is determined from an extension showing the maximum intensity. The strength is calculated by dividing the maximum intensity by the total fineness. The continuous strength and elongation product is determined by the following equation, and minimum and average values of the individual values measured 50 times are used to calculate the CV % thereof by the following equation.

$$Continuous strength and elongation product = strength [ cN / dtex ] \times ( 1 + elongation [ \% ] / 100 )$$

$$CV \% = ( standard deviation of continuous strength and elongation product ) / ( average continuous strength and elongation value ) \times 100$$

The nylon-66 fiber according to the embodiment of the present invention may contain various additives such as titanium oxide, an antistatic agent, a terminal group regulator, and a dyeability improver.

A content of titanium oxide in the nylon-66 fiber according to the embodiment of the present invention is preferably 0.01 wt % to 2 wt %. By containing 0.01 wt % or more of titanium oxide, whiteness of the fiber is improved, and a nylon-66 fiber having a good color tone can be obtained. By containing 2 wt % or less of titanium oxide, a nylon-66 fiber having high strength and elongation can be obtained.

A woven and knitted fabric according to the embodiment of the present invention contains the nylon-66 fiber described above. The nylon-66 fiber according to the embodiment of the present invention can be suitably used for a woven and knitted fabric. It is particularly suitable for a clothing use, and as a woven and knitted fabric for clothing, it can be used in a wide range of fields such as outerwear and innerwear.

A method for producing the nylon-66 fiber according to the embodiment of the present invention is a method for producing a nylon-66 fiber containing 20 wt % or more of a material-recycled polyhexamethylene adipamide resin, the method including a step of producing the polyhexamethylene adipamide resin, in which the step includes a step of cutting fiber scraps, a step of immersing the fiber scraps in hot water, a step of melting, filtering and discharging the fiber scraps, a step of water-cooling and cutting the discharged resin, and a step of immersing chips in hot water.

Hereinafter, a method for producing material-recycled polyhexamethylene adipamide resin chips (hereinafter referred to as nylon-66 chips) used for the nylon-66 fiber according to the embodiment of the present invention will be described.

The nylon-66 chips are preferably produced by cutting the fiber scraps generated in a step of producing the nylon-66 fiber, immersing the cut fiber scraps in hot water of 50° C. or higher to extract impurities (hot water extraction), melting, filtering and discharging the fiber scraps, water-cooling the discharged nylon-66 and cutting the discharged nylon-66 into chips, and then immersing the nylon-66 chips in hot water of 50° C. or higher as necessary to extract impurities (hot water extraction).

In the nylon-66 fiber according to the embodiment of the present invention, in order to control a molecular weight distribution on a low molecular weight side, a molecular weight distribution on a high molecular weight side, and yellowing (YI value), hot water extraction conditions, melting temperature, and filtration conditions of the fiber scraps are appropriately set to produce the chips.

The nylon-66 fiber scraps used in the production of the nylon-66 chips in the embodiment of the present invention are generated during the fiber production step, which include fiber scraps (washed-away scraps) generated between attachment to a spinneret and collection of fiber products such as drum packages, fiber scraps (yarn breakage scraps) generated due to yarn breakage problems during spinning or drawing step, and scraps (product scraps) obtained as a final form of fiber products such as drum packages but which fail product sorting, and any type of fiber scraps can be suitably used.

The nylon-66 chips used in the nylon-66 fiber according to the embodiment of the present invention may contain the various additives described above.

A content of titanium oxide in the nylon-66 chips is preferably 0.01 wt % to 2 wt %. By containing 0.01 wt % or more of titanium oxide, whiteness of the fiber is improved, and a nylon-66 fiber having a good color tone can be obtained. By containing 2 wt % or less of titanium oxide, a nylon-66 fiber having high strength and elongation can be obtained.

As described above, the nylon-66 chips in the embodiment of the present invention may contain various additives such as titanium oxide, but for example, in order to adjust the content of titanium oxide to a desired range, a content of titanium oxide in the nylon-66 fiber scraps used in the production must be known. In order to make it known, it is important not to mix nylon-66 fiber scraps with different contents of titanium oxide when collecting the nylon-66 fiber scraps, but in consideration of the fiber production step, it may be difficult to deal with washed-away scraps, yarn breakage scraps, and the like. In this case, product scraps which can easily be separated into nylon-66 fiber scraps having different contents of titanium oxide may be used. Furthermore, when the content of titanium oxide contained in the fiber scraps does not reach a desired content of titanium oxide in the nylon-66 chips, further titanium oxide may be added.

The step of producing the nylon-66 chips in the embodiment of the present invention preferably includes a step of cutting fiber scraps, a step of immersing the fiber scraps in hot water, a step of melting, filtering and discharging the fiber scraps, a step of water-cooling and cutting the discharged resin, and a step of immersing chips in hot water. Each step will be described below.

The nylon-66 fiber scraps generated during the fiber production step, regardless of whether they are washed-away scraps, yarn breakage scraps, or product scraps, are cut before being subjected to the hot water immersion and dehydration steps. This is to facilitate handling of the fiber scraps when the fiber scraps are subjected to the hot water immersion step and the dehydration step, and the subsequent melting, filtering and discharging step. If the fiber scraps are not cut to an appropriate length, the fibers may become tangled during the dehydration step, and inhibiting normal dehydration, or when the fiber scraps are fed into a melting hopper, they may not be fed normally to the melting unit, resulting in poor melting. The length to which the nylon-66 fiber scraps are cut should be such that the fiber scraps can be easily handled, and the length is set appropriately depending on a dehydrator, a melting device, and the like, and the fibers may be cut to a length of approximately 0.1 m to 1.0 m.

Among the washed-away scraps, yarn breakage scraps, and product scraps, the washed-away scraps and yarn breakage scraps may have clumps formed due to fibers fused together. Since scraps of this shape has a smaller specific surface area than the fiber scraps, it is not possible to efficiently remove low molecular weight impurities by hot water extraction. Therefore, when using the washed-away scraps or yarn breakage scraps, clumps of the scraps must be sorted and removed in advance. If this sorting and removal is difficult, only the product scraps may be used.

The cut fiber scraps are subjected to the hot water immersion step and the dehydration step. When nylon-66 is melted, a large amount of low molecular weight impurities derived from monomers and oligomers are produced. In addition, spinning oil is attached to the fiber scraps. For this reason, when nylon-66 is melted for material recycling, it is extremely important to remove these low molecular weight impurities and spinning oil in advance, and before melting the scraps for material recycling, the scraps are immersed in hot water to remove the low molecular weight impurities and spinning oil through hot water extraction.

A temperature of the hot water used for immersion may be 50° C. to 90° C. The temperature is preferably 70° C. to 90° C. By setting the temperature of hot water within this range, low molecular weight impurities can be efficiently removed from the fiber scraps, making it possible to produce nylon-66 chips containing low molecular weight impurities of 2.0 wt % or less, and the weight average molecular weight (Mw)/number average molecular weight (Mn) of the resulting nylon-66 fiber can be controlled to 4.5 or less. In the case where the temperature of hot water is lower than 50° C., the low molecular weight impurities will not be efficiently removed from the fiber scraps, making it difficult to produce nylon-66 chips containing 2.0 wt % or less of low molecular weight impurities. When the temperature of hot water is 90° C. or lower, the higher the temperature of hot water, the more efficiently the low molecular weight impurities can be removed from the fiber scraps, but even if the temperature of hot water exceeds 90° C., the efficiency of removing low molecular weight impurities does not improve any further.

In a de-oiling step for polyamide fiber scraps described in Patent Literature 1, the washing (extraction) temperature is unclear, and although it is effective in removing foreign matter resulting from spinning oil, it is insufficient in removing low molecular weight impurities contained in the polyamide fiber scraps, and as a result, the obtained material-recycled polyamide chips contain a large amount of low molecular weight impurities.

When immersed in hot water, the shape of the fiber scraps has a large surface area and is therefore prone to extremely rapid yellowing due to contact with oxygen contained in the water. Furthermore, nylon-66 is one among polyamides that tends to yellow quickly due to heat history. For this reason, a reducing agent is added to the extraction water to decompose the dissolved oxygen in the water and prevent yellowing. The reducing agent may be any compound capable of controlling the YI value of the nylon-66 fiber to 30 or less. Among these, compounds such as hydrazine hydrate and hydrazine carbonate are preferred.

The reducing agent is preferably added in an amount of 0.003 wt % or more based on an amount of the extraction water. By setting the adding amount of the reducing agent to 0.003 wt % or more, the YI value can be controlled to 30 or less.

A bath ratio when the cut fiber scraps are immersed in hot water should be such that low molecular weight impurities can be easily extracted from the fiber scraps, and the bath ratio is set appropriately depending on an extraction device, a production batch size when producing nylon-66 chips, and the like, and a ratio of fiber scraps weight:hot water weight may be approximately 1:3 to 1:10.

An immersion time for immersing the cut fiber scraps in hot water is preferably 20 minutes to 60 minutes. The immersion time is more preferably 30 minutes to 60 minutes. When the immersion time is 20 minutes or longer, low molecular weight impurities can be efficiently removed from the fiber scraps, making it possible to produce nylon-66 chips containing low molecular weight impurities of 2.0 wt % or less, and the weight average molecular weight (Mw)/number average molecular weight (Mn) of the resulting nylon-66 fiber can be controlled to 4.5 or less. When the immersion time is 60 minutes or shorter, the longer the immersion time, the more efficiently the low molecular weight impurities can be removed from the fiber scraps, but even if the immersion time exceeds 60 minutes, the efficiency of removing low molecular weight impurities does not improve any further.

The fiber scraps extracted with hot water is rinsed and then dehydrated. As for dehydration, it is sufficient that the fiber scraps are dehydrated until a moisture content thereof becomes 5 wt % to 15 wt %.

The fiber scraps extracted with hot water is subjected to melting, filtering and discharging steps. A melting method includes a pressure melter, an extruder, and the like, and nylon-66 chips can be produced by any of these melting methods. The extruder may be either a single-screw type or a twin-screw type.

A melting temperature when melting the fiber scraps may be 240° C. to 360° C. When the melting temperature is 240° C. or higher, it is possible to stably produce nylon-66 chips without un-melted parts and without problems such as an increased filtration pressure in a melting system. When the melting temperature is 360° C. or lower, and preferably 340° C. or lower, heat deterioration of the nylon-66 chips can be suppressed, and the z-average molecular weight (Mz)/weight average molecular weight (Mw) of the resulting nylon-66 fiber can be controlled to 2.5 or lower. By suppressing heat deterioration, yellowing can be prevented and the YI value can be controlled to 30 or less. An increase in viscosity due to heat history can be prevented, and the amino terminal group content CV % in the longitudinal direction of the fiber can be controlled to 8.0% or less, so that when subjected to dyeing, a high-quality woven and knitted fabric with desired color development and no dyeing difference can be obtained.

It is extremely important to filter the fiber scraps at the same time of melting. By performing filtration while melting, foreign matters can be removed from the nylon-66 chips, and as a result, an increase in an internal pressure of a spinning pack during the production of the nylon-66 fiber is prevented, thereby reducing spinning problems such as pack leakage and discharge abnormalities, and enabling production of the nylon-66 fiber with good operability.

It is preferable to use a filtration filter having a filtration precision of 5 μm to 50 μm. When the filtration precision is 5 μm or more, the fiber scraps can be stably melted without increasing the pressure in the melting system due to clogging of the filter. When the filtration precision is 50 μm or less, foreign matters can be removed from the nylon-66 chips. Regarding the filtration filter, any filter of a wire mesh type, a metal nonwoven fabric type, or a short metal fiber type can be used as long as it can perform filtration normally.

The nylon-66 fiber according to the embodiment of the present invention is a fine fiber particularly suitable for woven and knitted fabrics for clothing, and is also used for melt spinning, which is very strict in terms of production, and therefore, it is preferable to filter the nylon-66 chips to the utmost extent and remove foreign matters as many as possible. In order to remove as many foreign matters as possible, a mesh size of the filtration filter may be made finer, but simply making the mesh size of the filtration filter finer may cause clogging of the filter in the melting system, leading to a pressure increase and making it difficult to stably melt the fiber scraps when, for example, melting fiber scraps that contain a lot of additives such as titanium oxide. In this case, it is preferable to perform the filtration in two or more stages.

In the case where filtration is performed in two or more stages, the mesh size of the filtration filter is gradually made finer to increase the filtration precision. For example, when filtration is performed in two stages, the filtration of a first stage may be performed using a filtration filter having a filtration precision of 10 μm to 50 μm, and the filtration of a second stage may be performed using a filtration filter having a filtration precision of 5 μm to 20 μm, which is finer than that in the filtration of the first stage. When filtration is separated and performed in two stages, two or more filtration filters may be provided in one melting system, or pelletizing may be performed after melting and filtration, and pellets may be melted and filtered again.

The melting filtration time is preferably 5 min/kg or less. When the melting filtration time is 5 min/kg or less, the heat deterioration of the nylon-66 chips due to the heat history received during melt filtration can be prevented, yellowing of the resulting nylon-66 fiber can be prevented, and the YI value can be controlled to 30 or less. By preventing the heat deterioration, the z-average molecular weight (Mz)/weight average molecular weight (Mw), which is an index of the extent of high molecular weight components, can be controlled to 2.5 or less. An increase in viscosity due to heat history can be prevented, and the amino terminal group content CV % in the longitudinal direction of the fiber can be controlled to 8.0% or less, so that when subjected to dyeing, a high-quality woven and knitted fabric with desired color development and no dyeing difference can be obtained. Furthermore, by setting the melting filtration time to such a time, yellowing due to heat history can be prevented, and therefore a nylon-66 fiber can be provided without limiting uses thereof.

The molten and filtered nylon-66 resin is discharged from a spinneret for pelletization. When discharged from the spinneret, it is preferable to discharge pellets having a diameter of 1 mm to 3 mm in order to efficiently carry out hot water extraction of the nylon-66 chips, which will be described later.

The nylon-66 resin discharged from the spinneret is subjected to a water cooling step and a cutting step. The nylon-66 resin may be cooled with water to a degree that allows the nylon-66 resin to be easily cut. The nylon-66 resin may be cut by a known method, and it is preferable to cut the nylon-66 resin into a length of 1 mm to 4 mm in order to efficiently carry out the hot water extraction of the nylon-66 chips, which will be described later.

When the nylon-66 chips are subjected to a hot water immersion step, it is preferable to use hot water at the same temperature and to add the same reducing agent as in the case of fiber scraps, from the viewpoint of the efficiency of removing low molecular weight impurities.

The nylon-66 chips used in the nylon-66 fiber according to the embodiment of the present invention preferably have a 98% sulfuric acid relative viscosity (nr) of 2.2 to 3.8. More preferably, the 98% sulfuric acid relative viscosity (nr) is 2.5 to 3.5. Within this range, the average value of the continuous strength and elongation products can be set to 6.0 or more.

The nylon-66 chips used in the nylon-66 fiber according to the embodiment of the present invention preferably have an amino terminal group content of 3.5×10⁻⁵ mol/g or more. More preferably, the amino terminal group content is 4.0×10⁻⁵ mol/g to 5.8×10⁻⁵ mol/g. Within this range, excellent color development can be obtained using typical dyes (acid dyes) and methods (normal pressure dyeing) used in dyeing processing.

The nylon-66 chips used for the nylon-66 fiber according to the embodiment of the present invention preferably have a content of low molecular weight impurities of 2.0 wt % or less. More preferably, the content is 1.5 wt % or less. Within this range, the weight average molecular weight (Mw)/number average molecular weight (Mn) of the resulting nylon-66 fiber can be controlled to 4.5 or less.

The nylon-66 fiber according to the embodiment of the present invention is preferably produced by a production step including weighing the nylon-66 chips, or weighing and mixing the nylon-66 chips and virgin nylon-66 chips, and then drying the chips to adjust the moisture content thereof to a predetermined value, followed by so-called normal melt spinning, cooling, oiling, and drawing. A production device used in the embodiment of the present invention includes a mixer capable of weighing and mixing the nylon-66 chips and the virgin nylon-66 chips within a melt spinning device or separately from the melt spinning device. The melt spinning device used in the embodiment of the present invention may be either an extruder type spinning machine or a pressure melter type spinning machine. When a colorant is added, master chips to which a high concentration of the colorant is added may be mixed with base chips and the resulting mixed chips may be charged into the spinning machine, or each kind of the chips may be weighed above the spinning machine and charged directly. The colorant may be directly charged in a form of a powder or a liquid into the spinning machine.

The nylon-66 fiber according to the embodiment of the present invention can be obtained by a known melt spinning system in which only material-recycled nylon-66 chips or a combination of material-recycled nylon-66 chips and virgin nylon-66 chips mixed in a specific ratio are melted and discharged from the spinneret.

In the nylon-66 fiber according to the embodiment of the present invention, not only are the production conditions for the material-recycled nylon-66 chips described above appropriately set, but in order to further control the molecular weight distribution on the high molecular weight side and yellowing (YI value), melt spinning is performed by appropriately setting the moisture content of the chips and the filtration conditions and isolating the nylon-66 chips and molten polymers from oxygen in the air.

The nylon-66 chips used in the production of the nylon-66 fiber according to the embodiment of the present invention are adjusted by a drying step to have a moisture content of 600 ppm to 1500 ppm. The moisture content of the chips is preferably 700 ppm to 1200 ppm. It is known that nylon-66 chips undergo a polymerization reaction due to retention during melt spinning, leading to an increase in viscosity and a decrease in the amino terminal group content. Therefore, by controlling the moisture content of the nylon-66 chips to 600 ppm to 1500 ppm and controlling a polymerization equilibrium reaction, it is possible to prevent an increase in the viscosity of the polymers retained in a spinning pipe and to prevent a decrease in the amino terminal group content. Furthermore, since generation of heat deterioration products accompanying the increase in viscosity of the polymers is controlled, the z-average molecular weight (Mz)/weight average molecular weight (Mw) can be controlled to 2.5 or less. By preventing purification of the heat deterioration products accompanying the increase in viscosity, yellowing and variations in the amino terminal group content can also be prevented, so that a high-quality woven and knitted fabric with no dyeing differences can be obtained in dyeing. When the moisture content of the nylon-66 chips is less than 600 ppm, the viscosity of the polymers retained in the spinning pipe gradually increases, and the z-average molecular weight (Mz)/weight average molecular weight (Mw) and the amino terminal group content CV % also increase, and yellowing progresses. In the case where the moisture content of the nylon-66 chips exceeds 1500 ppm, hydrolysis of the nylon-66 retained in the spinning pipe is accelerated, the viscosity of the polymers drops drastically and varies, stable discharge is not possible, and the continuous strength and elongation product CV % increases. Therefore, in textile processing, yarn breakage or the like occurs starting from points having locally low strength and elongation products, resulting in poor passing performance in textile processing.

It is preferable to store the nylon-66 chips after drying or feed the nylon-66 chips into the spinning machine under a N₂ atmosphere. Polyamide is a polymer that is easily oxidized, and has characteristics of being easily oxidized and yellowed under an oxygen atmosphere or when exposed to oxygen in the air when it is hot. By using the N₂ atmosphere, yellowing can be prevented as much as possible, and the YI value can be controlled to 30 or less.

In the production of the nylon-66 fiber according to the embodiment of the present invention, a melt spinning temperature is preferably 240° C. to 320° C. The temperature is more preferably 260° C. to 300° C. Within this range, stable discharge can be achieved and heat deterioration of the polymer can be prevented.

A melt spinning pack used in the production of the nylon-66 fiber according to the embodiment of the present invention is a melt spinning pack including at least a spinneret, a pressure plate, a metal wire filter, and a sand filter layer or a straightening plate, and is a melt spinning pack in which a sintered filter made of short metal fibers having an approximately polygonal cross section is provided between the metal wire filter and the sand filter layer or the straightening plate.

Heat deterioration products of polymers are generated due to heat history received in a stage in which the fiber scraps and polymer scraps of polyamide generated in the fiber production step of the nylon-66 fiber are remelted to produce the material-recycled nylon-66 chips. Although such heat deterioration products of polymers are eliminated as much as possible during the chip production stage, the heat deterioration products may remain in the chips. In the recycled polyamide crimped fiber as described in Patent Literature 2, heat deterioration products remain, and when used in a woven and knitted fabric of the present invention, the amino terminal group content varies, which causes dyeing differences.

In order to break down the heat deterioration products of polymers and reduce the molecular weight distribution on the high molecular weight side, it is necessary to increase the filtration precision of the filtration filter and the sand filter layer or the straightening plate that constitute the melt spinning pack, and further to use a sintered filter made of short metal fibers having an approximately polygonal shape as the filtration filter. By using such a member, the short metal fibers are entangled with each other, and filtering and dispersing properties can be further improved. The approximately polygonal shape is preferably a cross section shape with acute angles. This is because acute angle parts of the cross section are denatured by heat, and the heat deterioration products of polymers can be finely dispersed by collision, and by making the cross section have more acute angles, the heat-denatured gelled polymers can be further broken down into smaller pieces. The filtration precision of the sintered filter made of short metal fibers is preferably 5 μm to 20 μm, depending on a discharge amount. By setting the filtration precision of the sintered filter made of short metal fibers within this range, the heat deterioration product can be finely dispersed, and the z-average molecular weight (Mz)/weight average molecular weight (Mw) can be controlled to 2.5 or less.

The nylon-66 fiber according to the embodiment of the present invention can be spun using a general spinneret designed with a predetermined number of discharge holes and a hole diameter and a hole length that enable stable discharge in accordance with a desired fineness and number of filaments.

In the production of the nylon-66 fiber according to the embodiment of the present invention, a surface of the spinneret is preferably under steam. By applying steam to the surface of the spinneret, it is possible to prevent the polymer discharged from the spinneret from coming into contact with oxygen in the air and oxidizing to yellow, and it is possible to control the YI value to 30 or less.

A melt-spun yarn is cooled and solidified by cold air, then coated with an oil, and then collected by a collection roller rotating at a predetermined collection speed. The collection speed is preferably 300 m/min to 4800 m/min. The collected yarn is usually subsequently drawn. Alternatively, an un-drawn yarn may be wound up once and then drawn in a separate step, or a drawn yarn may be wound up once and then crimped in a separate step.

The nylon-66 fiber according to the embodiment of the present invention is preferably drawn at a draw ratio in a range of 1.0 to 4.0 times so that the elongation becomes 30% to 100%.

### EXAMPLES

The present invention will now be described in more detail with reference to examples. Physical properties used in the present examples were measured as follows.

### A. 98% Sulfuric Acid Relative Viscosity

0.25 g of chips were dissolved in 100 ml of 98% sulfuric acid to form 1 g, and a flow-down time (T1) at 25° C. was measured using the Ostwald viscometer. Subsequently, a flow-down time (T2) of only 98% sulfuric acid was measured. A ratio of T1 to T2, that is, T1/T2, was defined as the 98% sulfuric acid relative viscosity.

### B. Content of Low Molecular Weight Impurities

(1) The chips were crushed and sieved through wire mesh filters of 35 mesh (opening 420 μm) and 115 mesh (opening 125 μm), and a powder that passed through the 35 mesh and remained on the 115 mesh was separated.
(2) The powder obtained in (1) was dried until a moisture content thereof was 0.03 wt % or less, and then weighed out approximately 3 g (W1).
(3) The powder weighed in (2) was extracted with 10 L or more of boiling water for 4 hours.
(4) The powder treated in (3) was washed with water, dried until the moisture content thereof was 0.03 wt % or less, and then weighed (W2).
(5) The content of low molecular weight impurities was calculated from W1 and W2 above using the following Equation.

$$Content of low molecular weight impurities ( wt \% ) = ( W 1 - W 2 ) / W 1 \times 10 \; 0 .$$

### C. Moisture Content

The chips were placed in a trace moisture meter, and the moisture therein was evaporated at 230° C. for 30 minutes, and a measured moisture value was taken as the moisture content.

### D. Amino Terminal Group Content, CV %

To prepare a solution, 1 g of the chips or fiber was dissolved in 50 mL of a phenol/ethanol mixed solution (phenol/ethanol=83.5/16.5 (volume ratio)) with shaking at 25° C. This solution was subjected to neutralization titration with 0.02N-hydrochloric acid, and an amount of 0.02N-hydrochloric acid required for the neutralization titration was determined. The phenol/ethanol mixed solution alone was subjected to neutralization titration with 0.02N-hydrochloric acid, and an amount of 0.02N-hydrochloric acid required for the neutralization titration was determined. An amino terminal group content per gram of chips or fiber was then calculated from a difference between the above two value.

Sampling of the amino terminal group content of the fiber was carried out by dividing a thickness of a fiber package into 5 equal parts and collecting 1 g from each layer, and the CV % was calculated by the following equation.

$$CV \% = ( standard deviation of amino terminal group content ) / ( average value of amino terminal group content ) \times 100.$$

### E. Total Fineness and Single Yarn Fineness

The fiber was measured at a specified yarn length of 100 m using a measuring machine manufactured by Toray Industries, Inc., based on JIS L1013 (2010) 8.3.1 Correct fineness a) Method A, with an initial load of indicated fineness×0.45 mN/dtex applied, so that a total fineness was calculated. A single yarn fineness was calculated by dividing the total fineness by the number of filaments.

F. Number Average Molecular Weight Mn, Weight Average Molecular Weight Mw, z-Average Molecular Weight Mz

The number average molecular weight (Mn), weight average molecular weight (Mw) and z-average molecular weight (Mz) were determined from a molecular weight distribution obtained by gel permeation chromatography (GPC). Specifically, the molecular weight distribution was measured using a gel permeation chromatograph (GPC) manufactured by Shimadzu Corporation as an apparatus and one “Shodex HEIP-G” column manufactured by Showa Denko K.K. and two “Shodex HEIP-606M” columns manufactured by Showa Denko K.K. As a measurement solvent, 5 mM of hexafluoroisopropanol containing sodium trifluoroacetate was used, and 3 mg of polymethyl methacrylate (PMMA) manufactured by Showa Denko K.K. as a standard sample and 3 mg of the fiber were used, which were gently stirred at room temperature (23° C.) and then filtered using a 0.45 μm filter to prepare a solution. The molecular weight distribution of the prepared sample solution was measured using a “RI-104” manufactured by Showa Denko K.K. as a refractive index detector under conditions of a column temperature of 40° C. and a flow rate of 0.2 ml/min.

Definition of each average molecular weight is shown below. Here, Mi indicates a molecular weight at each elution position of a GPC curve obtained via a molecular weight calibration curve, and Ni is the number of molecules.

$$Number average molecular weight Mn Mn = \sum ( Ni \times i ) / \sum Ni$$

$$Weight average molecular weight Mw Mw = \sum ( Ni \times {Mi}^{2} ) / \sum ( Ni \times Mi )$$

$$z - average molecular weight Mz Mz = \sum ( Ni \times {Mi}^{3} ) / \sum ( Ni \times {Mi}^{2} )$$

$$Distribution ratio Mw / Mn$$

$$Distribution ratio Mz / Mw$$

Mn indicates an average value associated with the low molecular weight components and Mz indicates an average value associated with the high molecular weight components. Mw/Mn is an index of the extent on the low molecular weight side, and Mz/Mw is an index of the extent on the high molecular weight side.

### G. Color Tone YI Value

The YI value was calculated from an average value of three measurements performed by winding the obtained fiber around a plastic plate using an aligned winding evaluation device manufactured by Eiko Sangyo Co., Ltd. in accordance with JIS K7105 (2006) and measuring the fiber using a multi-illuminant spectroscopy colorimeter (manufactured by Suga Test Instruments Co., Ltd.).

### H. Continuous Strength and Elongation Product

The fiber was subjected to 50 times (total length 25 m) of strength and elongation measurement using “Tensilon®” manufactured by ORIENTEC CO., LTD. in a temperature-controlled room at an air temperature of 20° C. and a humidity of 65% in accordance with JIS L1013 (2010) under constant-speed extension conditions of a grip interval of 50 cm and a tension rate of 50 cm/min. An intensity was determined from a point showing a maximum intensity on the tensile strength-elongation curve, and the elongation was determined from an extension showing the maximum intensity. The strength was calculated by dividing the maximum intensity by the total fineness. The continuous strength and elongation product was determined by the following equation, and minimum and average values of the individual values measured 50 times were used to calculate CV %.

$$Continuous strength and elongation product = strength [ cN / dtex ] \times ( 1 + elongation [ \% ] / 100 )$$

$$CV \% = ( standard deviation of strength and elongation product ) / ( average strength and elongation value ) \times 100$$

### I. Product Quality

Veteran inspectors visually checked the dyeing difference, streak quality, and color of the fabric, and gave an overall evaluation using the following scores of three levels.

### <Dyeing Difference, Streak Quality>

2 points: No dyeing differences or streaks, having excellent quality.
1 point: Slight dyeing differences or streaks, but no problem for use as a product.
0 point: having defects such as dyeing difference and streaks, and cannot be used as a product.

### <Color>

2 points: developing a desired color and having excellent quality.
1 point: color development is slightly inferior, but no problem for use as a product.
0 point: Poor color development and cannot be used as a product.

### <Overall Evaluation>

3 to 4 points: accepted product, 0 to 2 points: rejected product.

Note that the score in the overall evaluation is the sum of the scores for the above-mentioned <dyeing difference, streak quality> and <color tone>.

### J. Passing Performance in Textile Processing

Ten pieces of plain weave fabric (1000 m/piece) were woven on a water jet loom at a loom speed of 750 rpm and a weft length of 1620 mm, and the number of loom stoppages due to yarn breakage was evaluated according to the following criteria.
A: Less than 2 times
B: 2 times to less than 6 times
C: 6 times or more

A and B were deemed to have acceptable passing performance in textile processing.

### Example 1

### <Production of Material-Recycled Nylon-66 Chips>

From drum packages of a nylon-66 fiber containing 0.3 wt % of titanium oxide, drum packages that fails product sorting were collected, and the nylon-66 fiber was then cut into lengths of 0.1 m to 1.0 m.

The cut nylon-66 fiber scraps were placed in an extraction tank and hot water at 80° C. was added thereto so that a bath ratio of weight of fiber scraps:weight of hot water was 1:5, and a hydrazine hydrate manufactured by Tokyo Chemical Industry Co., Ltd. was added thereto as a reducing agent in an amount of 0.003 wt % relative to the amount of water. After immersion for 30 minutes while circulating the hot water with a circulation pump while maintaining the temperature of the hot water at 80° C., the fiber scraps were rinsed and dehydrated until a moisture content thereof is 5 wt % to 15 wt %.

The dehydrated fiber scraps were melted at a temperature of 340° C. in a pressure melter, and the molten polymer was introduced into a single-screw type extruder. A melting temperature in the extruder was set to 290° C., and the fiber scraps were melted while maintaining a tip pressure of 8 MPa, and filtered through a nonwoven fabric filter with a filtration precision of 20 μm. The filtered molten polymer was discharged from a spinneret, water-cooled, cut and pelletized once, and then melted and filtered for the second time by melting in a single-screw type extruder at a melting temperature of 290° C. while maintaining a tip pressure of 8 MPa, and filtering through a nonwoven fabric filter with a filtration precision of 10 μm. A discharge rate was adjusted so that a total melting filtration time was 5 min/kg. The filtered molten polymer was discharged from a spinneret, cooled with water, and cut into material-recycled nylon-66 chips having a diameter of 1.2 mm and a length of 2.0 mm.

The obtained material-recycled nylon-66 chips were placed in an extraction tank and hot water at 80° C. was added thereto so that a bath ratio of weight of pellets:weight of hot water was 1:5, and a hydrazine hydrate manufactured by Tokyo Chemical Industry Co., Ltd. was added thereto as a reducing agent in an amount of 0.003 wt % relative to the amount of hot water. While maintaining the temperature at 80° C., the chips were immersed for 30 minutes in hot water circulated by a circulation pump.

The content of low molecular weight impurities, the 98% sulfuric acid relative viscosity (nr), and the amino terminal group content of the obtained material-recycled nylon-66 chips are shown in Table 1.

### <Production of Nylon-66 Fiber>

A proportion of the material-recycled nylon-66 chips used was 100 wt %. The obtained material-recycled nylon-66 chips were dried to adjust the moisture content thereof to 1200 ppm. The chips with the adjusted moisture content were placed in a hopper under the N₂ atmosphere, then placed in a melting system in a spin block (spinning retaining box) at a temperature of 290° C., and melted at a spinning temperature of 290° C. using a pressure melter. The molten polymer was introduced into a spinning pack and discharged at a rate of 30 g/min per spinning pack. The spinning pack includes a spinneret (round hole), a pressure plate, a short metal fiber filter, and a sand filter medium, and the short metal fiber filter was a filter (filtration precision 10 μm) having an approximately polygonal cross section, a length of 1.0 mm to 3.0 mm, an equivalent diameter of 30 μm to 60 μm, and an aspect ratio of 10 to 100 variation, and made of stainless steel short fibers. Water vapor of 10 mmAq (1 mmAq=9.8067 Pa) was supplied to the surface of the spinneret from an injection hole (φ 2.0) provided at a bottom of the spinneret, and gas generated around the spinneret was forcibly removed with a suction wind speed of 25 m/min, and the fiber yarn was cooled with cold air having a wind temperature of 18° C. and a wind speed of 30 m/min, oiled by an oiling device, entangled by an entanglement nozzle device, so as to produce a nylon-66 fiber made of recycled materials with 25.8 dtex and 20 filaments at a winding speed of 4000 m/min. Properties of the obtained nylon-66 fiber are shown in Table 1.

### <Fabric Production>

Ten pieces of plain weave fabric (1000 m/piece) were woven on a water jet loom at a loom speed of 750 rpm and a weft length of 1620 mm, and the passing performance in textile processing and product quality of each piece are shown in Table 1.

### Example 2, Comparative Example 1

Material-recycled nylon-66 chips were produced in the same manner as in Example 1, except that when the cut nylon-66 fiber scraps and the material-recycled nylon-66 chips were each placed in an extraction tank and immersed in hot water, an addition rate of the reducing agent was changed as shown in Table 1 to produce material-recycled nylon-66 pellets. Nylon-66 fibers were produced. Results are shown in Table 1.

### Examples 3 to 4, Comparative Example 2

Material-recycled nylon-66 chips were produced in the same manner as in Example 1, except that when the cut nylon-66 fiber scraps and the material-recycled nylon-66 chips were each placed in an extraction tank and immersed in hot water, the temperature of the hot water was changed as shown in Table 1 to produce material-recycled nylon-66 pellets, and then nylon-66 fibers were produced. Results are shown in Table 1.

TABLE 1

| | | | | | | | | Comparative | Comparative |
|---|---|---|---|---|---|---|---|---|---|
| | | | | Example 1 | Example 2 | Example 3 | Example 4 | Example 2 | Example 1 |
| Material- | Hot water | Hot water temperature for scraps | ° C. | 80 | 80 | 50 | 90 | 40 | 80 |
| recycled | extraction | Presence or absence of reducing | — | Present | Present | Present | Present | Present | Absent |
| chips | (fiber | agent | | | | | | | |
| | scraps) | Amount of reducing agent | wt % | 0.003 | 0.01 | 0.003 | 0.003 | 0.003 | 0 |
| | Filtration | Melting temperature | ° C. | 340 | 340 | 340 | 340 | 340 | 340 |
| | | Filtration precision of filtration filter | μm | 20 | 20 | 20 | 20 | 20 | 20 |
| | | (first time) | | | | | | | |
| | | Filtration precision of filtration filter | μm | 10 | 10 | 10 | 10 | 10 | 10 |
| | | (second time) | | | | | | | |
| | | Melting filtration time | min/kg | 5 | 5 | 5 | 5 | 5 | 5 |
| | Hot water | Hot water temperature for chips | ° C. | 80 | 80 | 80 | 80 | 80 | 80 |
| | extraction | Presence or absence of reducing | — | Present | Present | Present | Present | Present | Absent |
| | (chips) | agent | | | | | | | |
| | | Amount of reducing agent | wt % | 0.003 | 0.01 | 0.003 | 0.003 | 0.003 | 0 |
| | Properties | Amount of low molecular weight | wt % | 1.3 | 1.3 | 1.6 | 1.2 | 3.1 | 1.3 |
| | of chips | impurities | | | | | | | |
| | | 98% sulfuric acid relative viscosity | — | 2.85 | 2.83 | 2.83 | 2.86 | 2.83 | 2.85 |
| | | Amino terminal group content | 10⁻⁵ mol/g | 5.6 | 5.5 | 5.5 | 5.6 | 5.5 | 5.6 |

| | | | | | | | | |
|---|---|---|---|---|---|---|---|---|
| Spinning | Moisture content of chips | ppm | 1200 | 1200 | 1200 | 1200 | 1200 | 1200 |
| conditions | Filtration filter | — | Short metal | Short metal | Short metal | Short metal | Short metal | Short metal |
| | | | fiber | fiber | fiber | fiber | fiber | fiber |
| | Filtration precision | μm | 10 | 10 | 10 | 10 | 10 | 10 |
| | Proportion of material-recycled nylon-66 | wt % | 100 | 100 | 100 | 100 | 100 | 100 |
| Raw yarn | Mw/Mn | — | 3.76 | 3.41 | 3.89 | 3.64 | 4.51 | 3.82 |
| properties | Mz/Mw | — | 1.69 | 1.65 | 1.65 | 1.69 | 1.64 | 1.78 |
| | Amino terminal group content | 10⁻⁵ mol/g | 5.5 | 5.5 | 5.5 | 5.5 | 5.5 | 5.6 |
| | Amino terminal group content CV % | — | 4.1 | 4.0 | 3.9 | 4.1 | 3.8 | 4.2 |
| | YI value | — | 22 | 18 | 21 | 23 | 20 | 31 |
| | Total fineness | dtex | 25.8 | 25.9 | 25.9 | 25.9 | 25.9 | 25.8 |
| | Single yarn fineness | dtex | 1.3 | 1.3 | 1.3 | 1.3 | 1.3 | 1.3 |
| | Continuous strength and elongation product | Average | 6.4 | 6.5 | 6.3 | 6.4 | 5.9 | 6.4 |
| | | value | | | | | | |
| | | CV % | 4.7 | 3.8 | 8.0 | 4.7 | 11 | 4.9 |
| | | Minimum | 5.2 | 5.7 | 4.1 | 5.3 | 3.7 | 5.2 |
| | | value | | | | | | |
| Evaluation | Passing performance in textile processing | — | A | A | A | A | C | A |
| | Dyeing difference and streak quality | Score | 2 | 2 | 2 | 2 | 2 | 1 |
| | Color | Score | 1 | 2 | 1 | 1 | 1 | 0 |
| | Overall evaluation | — | Accepted | Accepted | Accepted | Accepted | Rejected | Rejected |

### Example 5

Material-recycled nylon-66 chips were produced in the same manner as in Example 1, except that the material-recycled nylon-66 pellets obtained by melting were not put into the extraction tank and then the material-recycled nylon-66 pellets were produced, and then a nylon-66 fiber was produced. Results are shown in Table 2.

### Comparative Example 3

Material-recycled nylon-66 pellets were produced in the same manner as in Example 1, except that the melting filtration time was changed as shown in Table 2, and then a nylon-66 fiber was produced. Results are shown in Table 2.

### Example 6, Comparative Example 4

Material-recycled nylon-66 chips were produced in the same manner as in Example 1, except that the melting temperature of the fiber scraps obtained by hot water extraction was changed as shown in Table 2 to produce the material-recycled nylon-66 pellets, and then nylon-66 fibers were produced. Results are shown in Table 2.

TABLE 2

| | | | | | | | Comparative | Comparative |
|---|---|---|---|---|---|---|---|---|
| | | | | Example 1 | Example 5 | Example 6 | Example 3 | Example 4 |
| Material- | Hot water | Hot water temperature for scraps | ° C. | 80 | 80 | 80 | 80 | 80 |
| recycled | extraction | Presence or absence of reducing agent | — | Present | Present | Present | Present | Present |
| chips | (fiber | Amount of reducing agent | wt % | 0.003 | 0.003 | 0.003 | 0.003 | 0.003 |
| | scraps) | | | | | | | |
| | Filtration | Melting temperature | ° C. | 340 | 340 | 320 | 340 | 365 |
| | | Filtration precision of filtration filter | μm | 20 | 20 | 20 | 20 | 20 |
| | | (first time) | | | | | | |
| | | Filtration precision of filtration filter | μm | 10 | 10 | 10 | 10 | 10 |
| | | (second time) | | | | | | |
| | | Melting filtration time | min/kg | 5 | 5 | 5 | 8 | 5 |
| | Hot water | Hot water temperature for chips | ° C. | 80 | No | 80 | 80 | 80 |
| | | | | | extraction | | | |
| | extraction | Presence or absence of reducing agent | — | Present | Absent | Present | Present | Present |
| | (chips) | Amount of reducing agent | wt % | 0.003 | 0 | 0.003 | 0.003 | 0.003 |
| | Properties | Amount of low molecular weight | wt % | 1.3 | 1.8 | 1.3 | 1.3 | 1.4 |
| | of chips | impurities | | | | | | |
| | | 98% sulfuric acid relative viscosity | — | 2.85 | 2.83 | 2.82 | 2.7 | 3.1 |
| | | Amino terminal group content | 10⁻⁵ mol/g | 5.6 | 5.5 | 5.8 | 5.0 | 4.1 |

| | | | | | | | |
|---|---|---|---|---|---|---|---|
| Spinning | Moisture content of chips | ppm | 1200 | 1200 | 1200 | 1200 | 1200 |
| conditions | Filtration filter | — | Short metal | Short metal | Short metal | Short metal | Short metal |
| | | | fiber | fiber | fiber | fiber | fiber |
| | Filtration precision | μm | 10 | 10 | 10 | 10 | 10 |
| | Proportion of material-recycled nylon-66 | wt % | 100 | 100 | 100 | 100 | 100 |
| Raw yarn | Mw/Mn | — | 3.76 | 4.40 | 3.75 | 3.14 | 3.85 |
| properties | Mz/Mw | — | 1.69 | 1.64 | 1.60 | 2.55 | 2.52 |
| | Amino terminal group content | 10⁻⁵ mol/g | 5.5 | 5.5 | 5.4 | 3.4 | 3.2 |
| | Amino terminal group content CV % | — | 4.1 | 3.9 | 3.9 | 8.2 | 11.0 |
| | YI value | — | 22 | 23 | 22 | 32 | 32 |
| | Total fineness | dtex | 25.8 | 25.9 | 25.8 | 25.8 | 25.8 |
| | Single yarn fineness | dtex | 1.3 | 1.3 | 1.3 | 1.3 | 1.3 |
| | Continuous strength and elongation product | Average | 6.4 | 6.3 | 6.5 | 6.2 | 6.3 |
| | | value | | | | | |
| | | CV % | 4.7 | 5.1 | 4.3 | 2.6 | 3.4 |
| | | Minimum | 5.2 | 5.0 | 5.3 | 4.9 | 5.8 |
| | | value | | | | | |
| Evaluation | Passing performance in textile processing | — | A | B | A | B | B |
| | Dyeing difference and streak quality | Score | 2 | 2 | 2 | 1 | 1 |
| | Color | Score | 1 | 1 | 2 | 0 | 0 |
| | Overall evaluation | — | Accepted | Accepted | Accepted | Rejected | Rejected |

### Examples 7 and 8, Comparative Examples 5 and 6

Nylon-66 fibers were produced in the same manner as in Example 1, except that the moisture content of the material-recycled nylon-66 chips obtained in Example 1 during drying was changed as shown in Table 1. Results are shown in Table 3.

### Example 9

A nylon-66 fiber was produced in the same manner as in Example 1, except that the proportion of the material-recycled nylon-66 chips obtained in Example 1 was 50 wt %, and the proportion of virgin nylon-66 chips (amount of low molecular weight impurities: 1.3 wt %, 98% sulfuric acid relative viscosity: 2.85, amino terminal group content: 5.6×10⁻⁵ mol/g) was 50 wt %. Results are shown in Table 3.

TABLE 3

| | | | | | | | | Comparative | Comparative |
|---|---|---|---|---|---|---|---|---|---|
| | | | | Example 1 | Example 7 | Example 8 | Example 9 | Example 5 | Example 6 |
| Material- | Hot water | Hot water temperature for scraps | ° C. | 80 | 80 | 80 | 80 | 80 | 80 |
| recycled | extraction | Presence or absence of reducing | — | Present | Present | Present | Present | Present | Present |
| chips | (fiber | agent | | | | | | | |
| | scraps) | Amount of reducing agent | wt % | 0.003 | 0.003 | 0.003 | 0.003 | 0.003 | 0.003 |
| | Filtration | Melting temperature | ° C. | 340 | 340 | 340 | 340 | 340 | 340 |
| | | Filtration precision of filtration filter | μm | 20 | 20 | 20 | 20 | 20 | 20 |
| | | (first time) | | | | | | | |
| | | Filtration precision of filtration filter | μm | 10 | 10 | 10 | 10 | 10 | 10 |
| | | (second time) | | | | | | | |
| | | Melting filtration time | min/kg | 5 | 5 | 5 | 5 | 5 | 5 |
| | Hot water | Hot water temperature for chips | ° C. | 80 | 80 | 80 | 80 | 80 | 80 |
| | extraction | Presence or absence of reducing | — | Present | Present | Present | Present | Present | Present |
| | (chips) | agent | | | | | | | |
| | | Amount of reducing agent | wt % | 0.003 | 0.003 | 0.003 | 0.003 | 0.003 | 0.003 |
| | Properties | Amount of low molecular weight | wt % | 1.3 | 1.3 | 1.3 | 1.3 | 1.3 | 1.3 |
| | of chips | impurities | | | | | | | |
| | | 98% sulfuric acid relative viscosity | — | 2.85 | 2.85 | 2.85 | 2.85 | 2.85 | 2.85 |
| | | Amino terminal group content | 10⁻⁵ mol/g | 5.6 | 5.6 | 5.6 | 5.6 | 5.6 | 5.6 |

| | | | | | | | | |
|---|---|---|---|---|---|---|---|---|
| Spinning | Moisture content of chips | ppm | 1200 | 900 | 1500 | 1200 | 300 | 1600 |
| conditions | Filtration filter | — | Short metal | Short metal | Short metal | Short metal | Short metal | Short metal |
| | | | fiber | fiber | fiber | fiber | fiber | fiber |
| | Filtration precision | μm | 10 | 10 | 10 | 10 | 10 | 10 |
| | Proportion of material-recycled nylon-66 | wt % | 100 | 100 | 100 | 50 | 100 | 100 |
| Raw yarn | Mw/Mn | — | 3.76 | 3.75 | 3.75 | 3.31 | 3.84 | 3.78 |
| properties | Mz/Mw | — | 1.69 | 1.70 | 2.10 | 1.61 | 2.64 | 2.51 |
| | Amino terminal group content | 10⁻⁵ mol/g | 5.5 | 5.4 | 5.4 | 5.5 | 3.2 | 4.1 |
| | Amino terminal group content CV % | — | 4.1 | 4.2 | 4.3 | 3.5 | 12.0 | 11.0 |
| | YI value | — | 22 | 22 | 22 | 15 | 31 | 25 |
| | Total fineness | dtex | 25.8 | 25.8 | 25.8 | 25.8 | 25.8 | 25.8 |
| | Single yarn fineness | dtex | 1.3 | 1.3 | 1.3 | 1.3 | 1.3 | 1.3 |
| | Continuous strength and elongation product | Average | 6.4 | 6.1 | 6.5 | 6.5 | 6.3 | 6.3 |
| | | value | | | | | | |
| | | CV % | 4.7 | 5.1 | 4.3 | 4.1 | 3.4 | 14.0 |
| | | Minimum | 5.2 | 5.0 | 5.3 | 5.8 | 5.8 | 3.8 |
| | | value | | | | | | |
| Evaluation | Passing performance in textile processing | — | A | A | A | A | B | C |
| | Dyeing difference and streak quality | Score | 2 | 2 | 2 | 2 | 0 | 0 |
| | Color | Score | 1 | 2 | 2 | 2 | 0 | 0 |
| | Overall evaluation | — | Accepted | Accepted | Accepted | Accepted | Rejected | Rejected |

### Example 10

Material-recycled nylon-66 chips were produced in the same manner as in Example 1, except that the melting temperature of the fiber scraps obtained by hot water extraction was changed as shown in Table 4 to produce material-recycled nylon-66 pellets, and the proportion of the obtained material-recycled nylon-66 chips was 50 wt % and the proportion of virgin nylon-66 chips (amount of low molecular weight impurities: 1.3 wt %, 98% sulfuric acid relative viscosity: 2.85, amino terminal group content: 5.6×10⁻⁵ mol/g) was 50 wt %, and then a nylon-66 fiber was produced. Results are shown in Table 4.

### Examples 11 and 12

Material-recycled nylon-66 chips were produced in the same manner as in Example 1, except that when the cut nylon-66 fiber scraps were put into an extraction tank and immersed in hot water, the addition rate of the reducing agent was changed as shown in Table 4 to produce material-recycled nylon-66 pellets, and the proportions of the obtained material-recycled nylon-66 chips and the virgin nylon-66 chips (amount of low molecular weight impurities 1.3 wt %, 98% sulfuric acid relative viscosity 2.85, amino terminal group content 5.6×10⁻⁵ mol/g) were changed as shown in Table 4, and a nylon-66 fiber was produced in the same manner as in Example 1, except that the addition rate of the reducing agent was changed as shown in Table 4 when the material-recycle nylon-66 chips were placed in an extraction tank and immersed in hot water. Results are shown in Table 4.

### Reference Example 1

Material-recycled nylon-6 chips were produced in the same manner as in Example 1, except that a melting temperature of fiber scraps obtained by hot water extraction was changed as shown in Table 4 to produce material-recycled nylon-6 pellets, and then a nylon-6 fiber was produced. Results are shown in Table 4.

TABLE 4

| | | | | | | | | Reference |
|---|---|---|---|---|---|---|---|---|
| | | | | Example 1 | Example 10 | Example 11 | Example 12 | Example 1 (N6) |
| Material- | Hot water | Hot water temperature for scraps | ° C. | 80 | 80 | 80 | 80 | 80 |
| recycled | extraction | Presence or absence of reducing | — | Present | Present | Present | Present | Present |
| chips | (fiber | agent | | | | | | |
| | scraps) | Amount of reducing agent | wt % | 0.003 | 0.003 | 0.01 | 0.01 | 0.003 |
| | Filtration | Melting temperature | ° C. | 340 | 320 | 340 | 340 | 300 |
| | | Filtration precision of filtration filter | μm | 20 | 20 | 20 | 20 | 20 |
| | | (first time) | | | | | | |
| | | Filtration precision of filtration filter | μm | 10 | 10 | 10 | 10 | 10 |
| | | (second time) | | | | | | |
| | | Melting filtration time | min/kg | 5 | 5 | 5 | 5 | 5 |
| | Hot water | Hot water temperature for chips | ° C. | 80 | 80 | 80 | 80 | 80 |
| | extraction | Presence or absence of reducing | — | Present | Present | Present | Present | Present |
| | (chips) | agent | | | | | | |
| | | Amount of reducing agent | wt % | 0.003 | 0.003 | 0.01 | 0.01 | 0.003 |
| | Properties | Amount of low molecular weight | wt % | 1.3 | 1.3 | 1.3 | 1.3 | 0.6 |
| | of chips | impurities | | | | | | |
| | | 98% sulfuric acid relative viscosity | — | 2.85 | 2.85 | 2.85 | 2.85 | 2.6 |
| | | Amino terminal group content | 10⁻⁵ mol/g | 5.6 | 5.6 | 5.6 | 5.6 | 5.6 |

| | | | | | | | |
|---|---|---|---|---|---|---|---|
| Spinning | Moisture content of chips | ppm | 1200 | 1200 | 1200 | 1200 | 1200 |
| conditions | Filtration filter | — | Short metal | Short metal | Short metal | Short metal | Short metal |
| | | | fiber | fiber | fiber | fiber | fiber |
| | Filtration precision | μm | 10 | 10 | 10 | 10 | 10 |
| | Proportion of material-recycled nylon-66 | wt % | 100 | 50 | 50 | 20 | 100 |
| Raw yarn | Mw/Mn | — | 3.76 | 3.32 | 3.11 | 2.82 | 3.16 |
| properties | Mz/Mw | — | 1.69 | 1.35 | 1.52 | 1.60 | 1.60 |
| | Amino terminal group content | 10⁻⁵ mol/g | 5.5 | 5.5 | 5.5 | 5.5 | 5.5 |
| | Amino terminal group content CV % | — | 4.1 | 4.1 | 4.1 | 4.1 | 4.1 |
| | YI value | — | 22 | 22 | 22 | 22 | 13 |
| | Total fineness | dtex | 25.8 | 25.8 | 25.8 | 25.8 | 25.8 |
| | Single yarn fineness | dtex | 1.3 | 1.3 | 1.3 | 1.3 | 1.3 |
| | Continuous strength and elongation product | Average | 6.4 | 6.4 | 6.4 | 6.4 | 6.3 |
| | | value | | | | | |
| | | CV % | 4.7 | 4.7 | 4.7 | 4.7 | 4.0 |
| | | Minimum | 5.2 | 5.2 | 5.2 | 5.2 | 5.6 |
| | | value | | | | | |
| Evaluation | Passing performance in textile processing | — | A | A | A | A | A |
| | Dyeing difference and streak quality | Score | 2 | 2 | 2 | 2 | 2 |
| | Color | Score | 1 | 1 | 1 | 1 | 2 |
| | Overall evaluation | — | Accepted | Accepted | Accepted | Accepted | Accepted |

### INDUSTRIAL APPLICABILITY

The present invention can provide a recycled nylon-66 fiber which has the same raw yarn properties and passing performance in textile processing as a virgin nylon-66 fiber and can produce high-quality woven and knitted fabrics with excellent color tone.

Although the present invention has been described in detail with reference to specific embodiments, it is apparent to those skilled in the art that various changes and modifications can be made without departing from the spirit and the scope of the present invention.

1. A nylon-66 fiber having a color tone YI value of 30 or less, a weight average molecular weight Mw/number average molecular weight Mn of 4.5 or less, and a z-average molecular weight Mz/weight average molecular weight Mw of 2.5 or less, as determined by a molecular weight distribution obtained by GPC measurement.

2. The nylon-66 fiber according to claim 1, having a total fineness of 3 dtex to 200 dtex, a single yarn fineness of 0.2 dtex to 10 dtex, and a CV % of a continuous strength and elongation product of 10% or less.

3. The nylon-66 fiber according to claim 1, comprising 20 wt % or more of a material-recycled polyhexamethylene adipamide resin.

4. A method for producing the nylon-66 fiber according to claim 3, comprising:
a step of producing the polyhexamethylene adipamide resin, wherein
the step comprises a step of cutting fiber scraps, a step of immersing the fiber scraps in hot water, a step of melting, filtering and discharging the fiber scraps, a step of water-cooling and cutting the discharged resin, and a step of immersing chips in hot water.

5. A woven and knitted fabric comprising the nylon-66 fiber according to claim 1.
